(19) United States
(12) Patent Application Publication
(10) Pub. No.: US 2006/0261109 A1
(43) Pub. Date: Nov. 23, 2006

(54) Cargo container including an active material based releasable fastener system

(76) Inventors: Alan L. Browne, Grosse Pointe, MI (US); Nancy L. Johnson, Northville, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/131,491

(22) Filed: May 18, 2005

(51) Int. Cl. B60R 9/04; B60R 9/055

(52) U.S. Cl. 224/309; 224/328

(57) ABSTRACT

An active material based releasable fastener system for a vehicle carrier generally comprises a loop portion and a hook portion. A selected one of the hook portion or the loop portion is disposed on a surface of the carrier whereas an other selected one of the hook portion and the loop portion is disposed on a contact surface on which the carrier is disposed. When the loop portion and the hook portion are pressed together they interlock to form a releasable engagement being relatively resistant to shear and pull forces and weak in peel strength forces. The hook portion comprises a plurality of hook elements comprised of an active material. An activation signal applied to the active material causes a change in shape orientation, flexural modulus property, or a combination thereof to the hook elements that effectively reduces the shear and/or pull off forces in the releasable engagement. Disengagement of the releasable fastener system provides separation of the hook elements from the loop material under controlled conditions. In an alternative embodiment, each respective surface comprises a composite of the hook portion and the loop portion. Also disclosed is a process of operating the releasable fastener system for vehicle carriers.

### BACKGROUND

This disclosure generally relates to cargo containers including an active material based releasable fastener system.

Vehicle carriers (i.e., cargo containers) are commonly used to transport items that may not fit in the interior of the vehicle or in the trunk of the vehicle or may need additional stability within the vehicle. These vehicle carriers are often secured to a vehicle surface using complicated bracket systems or are fixedly mounted within a truck bed, for example. Current limitations of bracket systems include the amount of labor required for installation and the level of difficulty in removing the vehicle carriers. Thus, these vehicle carriers are often left on or in the vehicle for an extended period of time or permanently installed on or in the vehicle. With regard to fixed carriers, there is no versatility with regard to movement of the carrier.

There are other types of systems employed to secure the carrier to the vehicle surface. Typically, these systems include the use of straps such as rope, twine, cable, chain, utility straps, nylon or polypropylene straps, and the like to secure the carrier to the vehicle. These straps may include a buckle or a hook to allow the user to tighten and secure the vehicle carrier to the vehicle. Again, these types of systems are cumbersome and require time to effect release and attachment. Moreover, once secured by the strap, the carrier is very difficult to maneuver to a different location, if desired, thereby necessitating release in order to permit repositioning.

Accordingly, there remains a need in the art for cargo carriers that have improved releasable fastener systems that are relatively easy to operate and manipulate. It would be particularly advantageous for cargo carriers if the release fastener systems could be readily attached or released under controlled conditions.

### BRIEF SUMMARY

Disclosed herein are cargo containers generally including an active material based fastener system and methods of use. In one embodiment, the cargo container comprises a cargo container surface comprising a hook portion comprising a support, and a plurality of hook elements attached to the support, wherein the plurality of hook elements comprise an active material; and an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the hook portion is engaged with a loop portion.

In combination with a vehicle and a cargo container, the combination comprises the vehicle comprising a contact surface having a selected one of a loop portion or a hook portion disposed thereon, wherein the loop portion comprises a loop material, and wherein the hook portion comprises a plurality of hook elements attached to the surface, wherein the plurality of hook elements comprise an active material; the cargo container a surface having an other of the selected one of the loop portion or the hook portion disposed thereon; and an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the hook portion is engaged with the loop portion.

In another embodiment, the combination of the vehicle and the cargo container comprises the vehicle comprising a contact surface having a first engageable portion disposed thereon, wherein the first engageable portion comprises a plurality of hook elements or a loop material or a composite of the hook elements and the loop material, wherein the plurality of hook elements comprise an active material; the cargo container a surface having a second engageable portion, wherein the second engageable portion comprises the plurality of hook elements or the loop material or the composite of the hook elements and the loop material; and an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the first engageable portion is engaged with the second engageable portion.

A process for securing and releasing a cargo container to and from a vehicle comprises providing the vehicle with a contact surface, wherein the contact surface comprises a loop material, a hook material, or a combination thereof; contacting the cargo container with the contact surface, wherein the cargo container comprises a plurality of hook elements, loop elements, or a combination thereof formed of an active material, wherein contacting the cargo container comprises pressing the plurality of hook elements to the loop material to form a releasable engagement; selectively introducing an activation signal to the plurality of hook elements, wherein the activation signal is effective to change a shape orientation, a flexural modulus property, or the combination thereof to the plurality of hook elements; and reducing shear and/or pull off forces in the releasable engagement.

The above described and other features are exemplified by the following figures and detailed description.

### BRIEF DESCRIPTION OF THE DRAWINGS

Referring now to the figures, which are exemplary embodiments and wherein the like elements are numbered alike:

FIG. 1 is a plan view of a cargo container disposed on a rooftop of a vehicle, wherein the cargo carrier includes an active material based fastener system;

FIG. 2 is a cross sectional view of an engaged active material based fastener system for the cargo container in accordance with one embodiment;

FIG. 3 is a cross sectional view of a disengaged active material based releasable fastening system of FIG. 2; and

FIG. 4 is a cross sectional view of a disengaged active material based releasable fastening system of FIG. 2 in accordance with another embodiment.

### DETAILED DESCRIPTION

Disclosed herein are cargo containers that include active material based releasable fasteners and methods of use. The active material based releasable fasteners fasten, retain, or latch the cargo container to a selected surface that can be separated or released under controlled conditions. The selected surface can be interiorly or exteriorly located on the vehicle. The term “active material” as used herein refers to several different classes of materials all of which exhibit a change in at least one attribute such as dimension, shape, and/or flexural modulus when subjected to at least one of many different types of applied activation signals, examples of such signals being thermal, electrical, magnetic, stress, and the like. It is this change in the at least one attribute that provides selective attachment and release of the cargo container.

One class of active materials is shape memory materials. These exhibit a shape memory. Specifically, after being deformed pseudoplastically, they can be restored to their original shape by the application of the appropriate field. In this manner, shape memory materials can change to a pre-determined shape in response to an activation signal. Suitable shape memory materials include, without limitation, shape memory alloys (SMA), ferromagnetic SMAs (FSMA), and shape memory polymers (SMP). A second class of active materials can be considered as those that exhibit a change in at least one attribute when subjected to an applied field but revert back to their original state upon removal of the applied field. Active materials in this category include, but are not limited to, electroactive polymers (EAP), two-way trained shape memory alloys, magnetorheological fluids and elastomers (MR), composites of one or more of the foregoing materials with non-active materials, combinations comprising at least one of the foregoing materials, and the like. Depending on the particular active material, the activation signal can take the form of, without limitation, an electric current, a temperature change, a magnetic field, a mechanical loading or stressing, or the like. Of the above noted materials, SMA and SMP based fastener systems may further include a return mechanism to restore the original geometry of the fastener. The return mechanism can be mechanical, pneumatic, hydraulic, pyrotechnic, or based on one of the aforementioned smart materials. For example, a bias spring can be used.

Cargo containers, also referred to herein as cargo carriers, are generally designed to transport items that may not fit in the vehicle or in the trunk or may be used for items where it is preferred to transport outside of the vehicle interior or may be used for items where stability during transport is a concern. There are many types of carriers available, which may be mounted onto a vehicle roof, atop vehicle trunk, onto a crossbar of a vehicle, a rack of a vehicle or a support attached to the vehicle, truck bed, interior surface, and the like. The present disclosure is not intended to be limited to any particular type of carrier or location within and about the vehicular environment. Moreover, the cargo carrier is not intended to be limited to automotive applications, although for ease of understanding reference will be made herein to cargo containers for automotive applications. Other suitable applications may include, for example, cargo containers for tractor trailers, airplanes, trains, ships, vans, recreational vehicles, shopping carts, and the like. For automotive applications, the carriers are releasably attached to the vehicle surface such as a roof top surface, an interior surface, a truck bed surface, trunk surface, trunk interior surface, and the like. Alternatively, the carriers including the active material based fastener systems can be releasably attached to one another, if desired.

By utilizing the active material based fastener system for vehicle carriers, the carriers can be releasably attached to a vehicle surface. The active material based releasable fastener system can reversibly change its shape orientation and/or modulus property to provide the release or separation of the carrier from the vehicle surface on demand as well as provide secure engagement, where desired and configured. Applying a suitable activation signal to the active material can effect the reversible change.

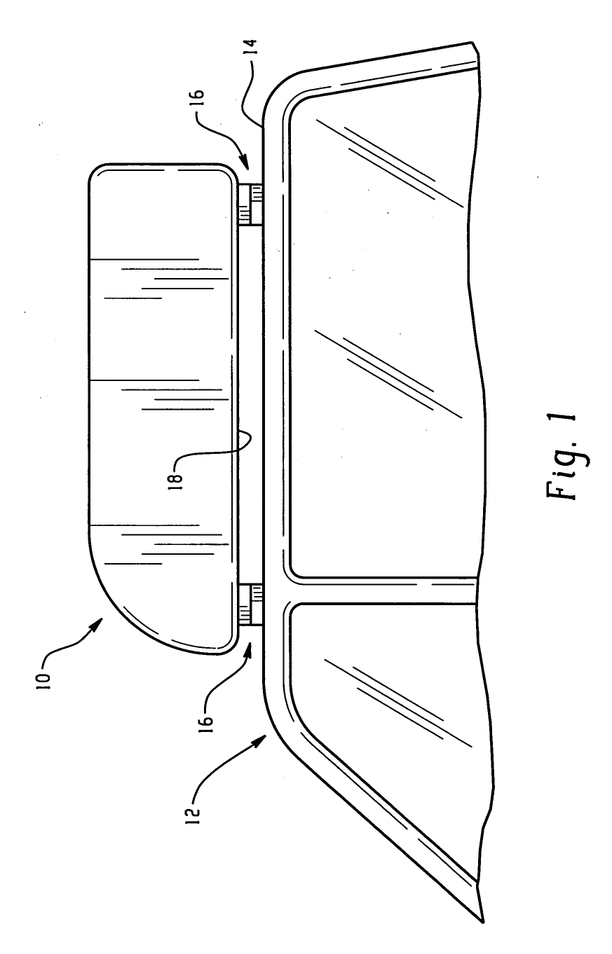

Referring now to FIG. 1, there is shown an exemplary cargo container generally designated by reference numeral 10 disposed on a rooftop 12 of a vehicle 14. The cargo container 10 includes one or more active material based releasable fasteners 16 for releasable engagement with a selected vehicle surface. The active material based releasable fasteners is disposed on a surface 18 of the carrier 10 that contacts the desired vehicle surface. The illustrated cargo container 10 is exemplary and is not intended to be limited to any particular size and/or shape.

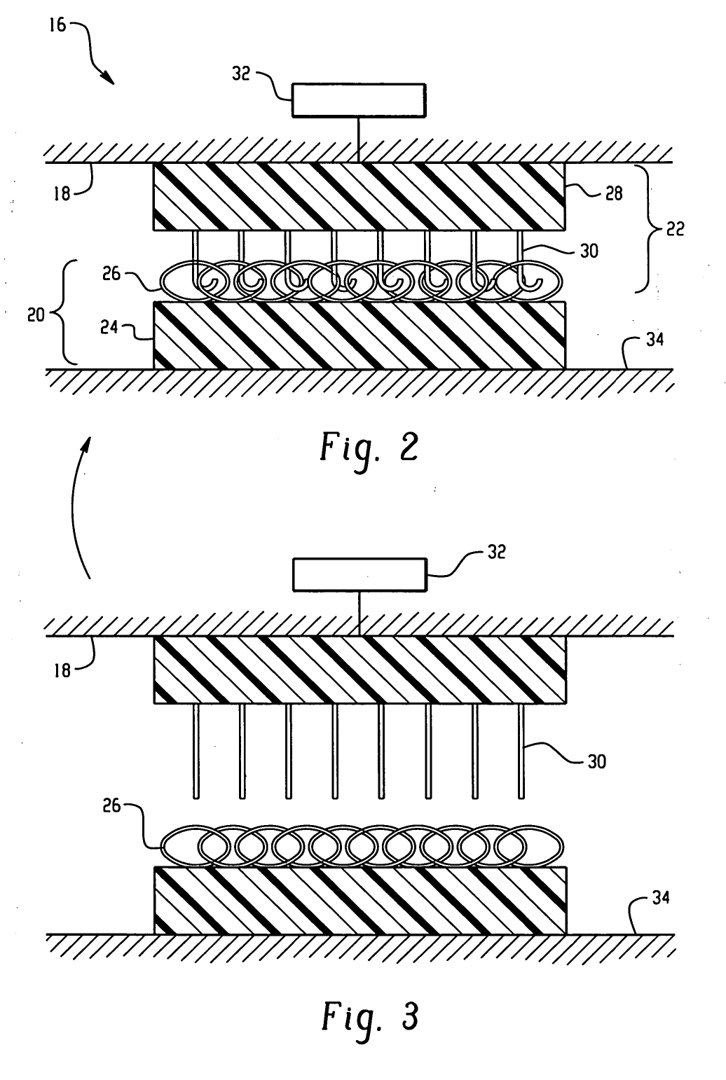

FIG. 2 illustrates an enlarged view of the active material based releasable fastener 16 of FIG. 1 in accordance with one embodiment. The active material based fastener system 16 generally comprises a loop portion 20 and a hook portion 22. The loop portion 20 includes a loop support 24 and a loop material 26 disposed on one side thereof whereas the hook portion 22 includes a hook support 28 and a plurality of closely spaced upstanding hook elements 30 extending from one side thereof. The hook elements 30 are generally comprised of the active materials. A single hook element can be formed of one or more different active materials, a composite of one or more active materials with non-active materials, and the like. The active material in any of these embodiments provides the plurality of hook elements 30 with a shape changing capability and/or a flexural modulus property change capability that can be tuned to a particular application, as will be described in greater detail.

Coupled to and in operative communication with the plurality of hook elements 30 is an activation device 32. The activation device 32, on demand, provides an activation signal or stimulus to the hook elements 30 to cause a change in the shape orientation and/or flexural modulus properties of at least some of the hook elements 30. The change in shape orientation and/or flexural modulus property generally remains for the duration of the applied activation signal. Upon discontinuation of the activation signal, the hook elements 30 revert to an unpowered shape. The illustrated releasable fastener system 10 is exemplary only and is not intended to be limited to any particular shape, size, configuration, number or shape of hook elements 30, shape of loop material 26, active material, or the like.

Adjacent hook elements 30 are at a distance that is effective to provide sufficient shear and pull off resistance desired for the particular application during engagement with the plurality of loops 26. As used herein, the term “shear” refers to an action or stress resulting from applied forces that causes or tends to cause two contiguous parts of a body to slide relatively to each other in a direction parallel to their plane of contact. The term “pull force” refers to an action or stress resulting from applied forces that causes or tends to cause two contiguous parts of a body to move relative to each other in a direction perpendicular to their plane of contact. Depending on the desired application, the amount of shear and pull-off force required for effective engagement can vary significantly. Generally, the closer the spacing and the greater amount of hook elements 30 employed will result in increased shear and pull off forces upon engagement. Other factors resulting in increased shear and pull off forces upon engagement are the size of the plurality of hooks 30 and loops 26, types of material employed and the distribution of the hooks and loops placed in strategic positions. The plurality of hook elements 30 preferably have a shape configured to become engaged with the plurality of loops 26 upon pressing contact of the loop material 26 with the hook elements 30, and vice versa. In this engaged mode, the plurality of hook elements 30 can have a reverse or an inverted J-shaped orientation, a mushroom shape, a knob shape, a multi-tined anchor, T-shape, spirals, or any other mechanical form of a hook-like element used for separable hook and loop fasteners. Such elements are referred to herein as “hook-like”, “hook-type”, or “hook” elements whether or not they are in the shape of a hook. Likewise, the plurality of loops may comprise a pile, a shape complementary to the hook element (e.g., a key and lock type engagement), or any other mechanical form of a loop-like element used for separable hook and loop fasteners.

The plurality of loops 26 generally comprises a random looped pattern, entangled thread or a pile of a material. The loop material is often referred to as the “soft”, the “fuzzy”, the “pile”, the “female”, or the “carpet”. Materials suitable for manufacturing the loop material include thermoplastics such as polypropylene, polyethylene, polyamide, polyester, polystyrene, polyvinyl chloride, acetal, acrylic, polycarbonate, polyphenylene oxide, polyurethane, polysulfone, and the like. Other materials that may be used include metals and fabrics. The plurality of loops 26 may be attached to a support, a rack, a crossbar, a vehicle carrier, a vehicle surface directly, and/or the cargo container or any combination thereof.

The hook portion 22 can be disposed on any surface of the cargo container 10 that contacts an opposing surface 34 to which the cargo container 10 is to be placed, e.g., a vehicle roof, another cargo container, and the like and/or a support, a rack, a crossbar, a vehicle carrier, or vehicle surface directly. As such, the hook portion 20 can be integrated or attached to the surface 18 of the cargo container 10. Likewise, the loop portion 20 can be integrated with or attached to the surface 34 desired for which the cargo container is to be placed and releasably fastened, e.g., roof rails, truck bed, interior floor surface, another cargo container, and the like. In this manner, the loop portion 20 is not intended to be limited to any particular shape or form. For example, for roof top applications, the loop portion can be in the form of a strap, or may be in the form of a movable block within a rail system or the like. Optionally, the loop portion 20 can be disposed on the cargo container surface 18 and the hook portion 22 can be disposed on the opposing contact surface 34. It should be noted that, unlike traditional hook and loop fasteners, supports 24, 28 could be fabricated from a rigid or inflexible material in view of the remote releasing capability provided. Traditional hook and loop fasteners typically require at least one support to be flexible so that a peeling force can be applied for separation. Still further, it is contemplated that each surface can comprise a plurality of hooks and loops.

During engagement, the cargo container 10 is positioned onto the surface 34 such that the hook and loop portions 22, 20, respectively, are pressed together to create a joint that is relatively strong in the shear and/or pull-off directions. For example, as shown in FIG. 2, when the two portions 20, 22 are pressed into face-to-face engagement, the plurality of hook elements 30 become engaged with the loop material 26 and the close spacing of the hook elements 30 resists substantial lateral movement when subjected to shearing forces in the plane of engagement. Similarly, when the engaged joint is subjected to a force substantially perpendicular to this plane, (i.e., pull-off forces), the hook elements 30 resist substantial separation of the two portions 20, 22.

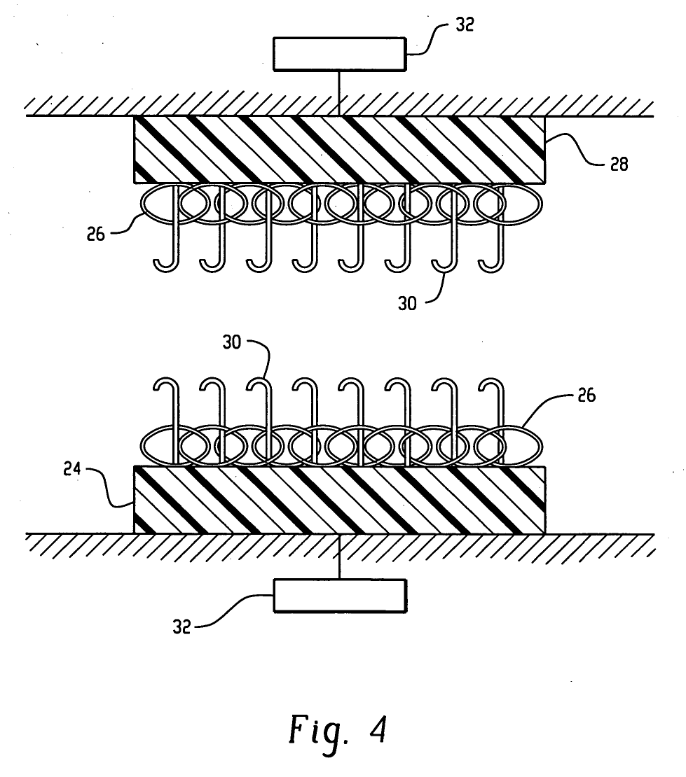

To reduce the shear and pull-off forces resulting from the engagement, the shape orientation and/or flexural modulus properties of the hook elements 30 are altered upon receipt of a suitable activation signal from the activation device 32 to provide a remote releasing mechanism of the engaged joint. That is, the change in shape orientation and/or flexural modulus of at least some of the hook elements 30 reduces the shearing forces in the plane of engagement, and reduces the pull off forces perpendicular to the plane of engagement. For example, as shown in FIGS. 2 and 3, the plurality of hook elements 30 can have inverted J-shaped orientations that are changed, upon demand, to substantially straightened shape orientations upon receiving the activation signal from the activation device 32. Functioning in a similar manner, FIG. 4 illustrates a composite of hook elements 30 and loop material 26 disposed in each support 28, 24.

The substantially straightened shape relative to the J-shaped orientation provides the joint with marked reductions in shear and/or pull-off forces. Similarly, a reduction in shear and/or pull off forces can be observed by changing the yield strength and/or flexural modulus of the hook elements 30. The change in yield strength and/or flexural modulus properties can be made independently, or in combination with the change in shape orientation. For example, changing the flexural modulus properties of the hook elements 30 to provide an increase in flexibility will reduce the shear and/or pull-off forces. Conversely, changing the flexural modulus properties of the hook elements 30 to decrease flexibility (i.e., increase stiffness) can be used to increase the shear and pull-off forces when engaged. Similarly, changing the yield strength properties of the hook elements to increase the yield strength can be used to increase the shear and pull-off forces when engaged. In both cases, the holding force is increased, thereby providing a stronger joint.

The activation device 32, on demand, provides a suitable activation signal to the plurality of hook elements 30 to cause a change in the shape orientation and/or flexural modulus. The activation device 32 may be a battery, current carrying circuits within the vehicle, and the like. The change in shape orientation and/or flexural modulus property generally remains for the duration of the applied activation signal. Upon discontinuation of the activation signal, the plurality of hook elements 30 reverts substantially to a non-activated shape and/or stiffness. Discontinuation occurs when the activation signal is no longer applied.

The activation signal may be supplied in a variety of ways. For example, a thermal activation signal may be supplied using hot gas (e.g. air), steam, or an electrical current. A primary means of thermal activation is resistive heating. For example, the activation device 32 can include a battery mounted within the cargo container. A button or switch in electrical communication can be activated to provide a resistive heating to the hook elements 30. Another example is to have a remote key fob send a signal to the activation device to initiate the activation to the battery.

The support 28 may also comprise the activation device 32 for providing the thermal activating signal to the hook elements 30. For example, the support may be a resistance type heating block to provide a thermal energy signal sufficient to cause a shape change and/or change in flexural modulus as required for hook elements fabricated from shape memory alloys and shape memory polymers, and like thermally activated materials.

Shape memory alloys exist in several different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is called the austenite finish temperature (Af). When the shape memory alloy is in the austenite phase and is cooled, it begins to change into the martensite phase, and the temperature at which this phenomenon starts is referred to as the martensite start temperature (Ms). The temperature at which austenite finishes transforming to martensite is called the martensite finish temperature (Mf). Generally, the shape memory alloys are softer and more easily deformable in their martensitic phase and are harder, stiffer, and/or more rigid in the austenitic phase. In view of the foregoing properties, expansion of the shape memory alloy is preferably at or below the austenite transition temperature (at or below As). Subsequent heating above the austenite transition temperature causes the expanded shape memory to revert back to its permanent shape. Thus, a suitable activation signal for use with shape memory alloys is a thermal activation signal having a magnitude to cause transformations between the martensite and austenite phases.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing shape memory effects, super elastic effects, and high damping capacity.

Suitable shape memory alloy materials include, but are not intended to be limited to, nickel-titanium based alloys, indium-titanium based alloys, nickel-aluminum based alloys, nickel-gallium based alloys, copper based alloys (e.g., copper—zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape orientation, changes in yield strength, and/or flexural modulus properties, damping capacity, superelasticity, and the like. Selection of a suitable shape memory alloy composition depends on the temperature range where the component will operate.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be shaped. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but riot to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent from the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

The shape memory polymer may be heated by any suitable means. For example, for elevated temperatures, heat may be supplied using hot gas (e.g., air), steam, hot liquid, or electrical current. The activation means may, for example, be in the form of heat conduction from a heated element in contact with the shape memory polymer, heat convection from a heated conduit in proximity to the thermally active shape memory polymer, a hot air blower or jet, microwave interaction, resistive heating, and the like. In the case of a temperature drop, heat may be extracted by using cold gas, evaporation of a refrigerant, thermoelectric cooling, or by simply removing the heat source for a time sufficient to allow the shape memory polymer to cool down via thermodynamic heat transfer. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory polymer.

Suitable polymers for use in the SMPs include thermoplastics, thermosets, interpenetrating networks, semi-interpenetrating networks, or mixed networks of polymers. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and the like, and combinations comprising at least one of the foregoing polymer components. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). The polymer(s) used to form the various segments in the SMPs described above are either commercially available or can be synthesized using routine chemistry. Those of skill in the art can readily prepare the polymers using known chemistry and processing techniques without undue experimentation.

Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, and the like.

Electroactive polymers include those polymeric materials that exhibit piezoelectric, pyroelectric, or electrostrictive properties in response to electrical or mechanical fields. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

Advantageously, the releasable fastener systems for vehicle carriers are used to release and/or separate the engagement under controlled conditions. For example, the releasable fasteners for vehicle carriers can be employed to releasably attach two vehicle carriers or a vehicle carrier to a vehicle. Likewise, the releasable fastener systems can be configured to provide relatively ease in positioning of different carriers. For example, a box shaped carrier can be utilized for carrying groceries or other objects and configured with the releasable fastener system. The bottom portion of the box can be fitted with one of the hook and loop portion (or composite of both hook and loops as shown in FIG. 4) and a floor surface within the vehicle can be fitted with the other. Selective activation and deactivation can be used to readily reposition the box.

It should also be noted that the releasable fastener systems for vehicle carriers could be configured such that an energy source is not required to maintain engagement of the joint. Thermal activation from an activation signal can be used to provide separation, thereby minimizing the impact on energy sources during use of the releasable fastener system for a vehicle carrier.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A cargo container, comprising:
a cargo container surface comprising a hook portion comprising a support, and a plurality of hook elements attached to the support, wherein the plurality of hook elements comprise an active material; and
an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the hook portion is engaged with a loop portion.

2. The cargo container of claim 1, wherein the plurality of hook elements are distributed about the hook support in an amount effective to provide a secure attachment and a release upon the activation signal.

3. The cargo container of claim 1, wherein the plurality of hook elements in an absence of the activation signal comprise a shape orientation comprising a J-shaped orientation, a mushroom shape, a knob shape, a multi-tined anchor shape, a T-shape, a spiral shape, or combinations comprising at least one of the foregoing shapes.

4. The cargo container of claim 1, wherein the active material comprises a shape memory alloy, a shape memory polymer, a ferromagnetic shape memory alloy, an electroactive polymer, and a magnetorheological elastomer, or combinations of the foregoing, or combinations of the foregoing with a non-active material.

5. The cargo container of claim 1, wherein the activation signal comprises a heat signal, a magnetic signal, an electromagnetic signal, an electrical signal, or combinations comprising at least one of the foregoing signals.

6. The cargo container of claim 1, wherein the loop portion comprises a support and a loop material disposed on the support, wherein the loop portion is adapted for attachment to a contact surface upon which the cargo container is releasably attached thereto.

7. In combination, a vehicle and a cargo container, comprising:
the vehicle comprising a contact surface having a selected one of a loop portion or a hook portion disposed thereon, wherein the loop portion comprises a loop material, and wherein the hook portion comprises a plurality of hook elements attached to the surface, wherein the plurality of hook elements comprise an active material;
the cargo container a surface having an other of the selected one of the loop portion or the hook portion disposed thereon, and
an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the hook portion is engaged with the loop portion.

8. The combination of the vehicle and the cargo container of claim 7, wherein the active material comprises a shape memory alloy, a shape memory polymer, a ferromagnetic shape memory alloy, an electroactive polymer, and a magnetorheological elastomer, or combinations of the foregoing, or combinations of the foregoing with a non-active material.

9. The combination of the vehicle and the cargo container of claim 7, wherein the activation signal comprises a heat signal, a magnetic signal, an electromagnetic signal, an electrical signal, or combinations comprising at least one of the foregoing signals.

10. The combination of the vehicle and the cargo container of claim 7, wherein the shape orientation to the plurality of hook elements changes from an inverted J-shaped orientation to a substantially straightened shape orientation upon receipt of the activation signal.

11. The combination of the vehicle and the cargo container of claim 7, wherein the loop material comprises a shape adapted to be engaged with the hook elements when the hook portion is pressed into face-to-face engagement with the loop portion.

12. A process for securing and releasing a cargo container to and from a vehicle, the process comprising:
providing the vehicle with a contact surface, wherein the contact surface comprises a loop material;
contacting the cargo container with the contact surface, wherein the cargo container comprises a plurality of hook elements formed of an active material, wherein contacting the cargo container comprises pressing the plurality of hook elements to the loop material to form a releasable engagement;
selectively introducing an activation signal to the plurality of hook elements, wherein the activation signal is effective to change a shape orientation, a flexural modulus property, or the combination thereof to the plurality of hook elements; and
reducing shear and/or pull off forces in the releasable engagement.

13. The process of claim 12, wherein the active material comprises a shape memory alloy, a shape memory polymer, a ferromagnetic shape memory alloy, an electroactive polymer, and a magnetorheological elastomer, or combinations of the foregoing, or combinations of the foregoing with a non-active material.

14. The process of claim 12, wherein the activation signal comprises a heat signal, a magnetic signal, an electromagnetic signal, an electrical signal, or combinations comprising at least one of the foregoing signals.

15. The process of claim 12, wherein the contact surface comprises a truck bed, a roof top, a trunk bed, an additional cargo container, an interior surface, or a rail system.

16. In combination, a vehicle and a cargo container, comprising:
the vehicle comprising a contact surface having a first engageable portion disposed thereon, wherein the first engageable portion comprises a plurality of hook elements or a loop material or a composite of the hook elements and the loop material, wherein the plurality of hook elements comprise an active material;
the cargo container a surface having a second engageable portion, wherein the second engageable portion comprises the plurality of hook elements or the loop material or the composite of the hook elements and the loop material; and
an activation device coupled to the plurality of hook elements, the activation device being operable to selectively provide an activation signal to the plurality of hook elements to change a shape orientation, a yield strength property, a flexural modulus property, or a combination thereof to reduce a shear force and/or a pull-off force when the first engageable portion is engaged with the second engageable portion.

17. The combination of claim 16, wherein the active material comprises a shape memory alloy, a shape memory polymer, a ferromagnetic shape memory alloy, an electroactive polymer, and a magnetorheological elastomer, or combinations of the foregoing, or combinations of the foregoing with a non-active material.

18. The combination of claim 16, wherein the activation signal comprises a heat signal, a magnetic signal, an electromagnetic signal, an electrical signal, or combinations comprising at least one of the foregoing signals.
